(19) United States
(12) Patent Application Publication
(10) Pub. No.: US 2008/0205304 A1
(43) Pub. Date: Aug. 28, 2008

(54) System and Method for Real-Time Communications Over HTTP

(76) Inventors: Michael Shivas, Los Angeles, CA (US); Barry Sohl, Huntington Beach, CA (US)

Correspondence Address: TOWNSEND AND TOWNSEND AND CREW LLP/EA, TWO EMBARCADERO CENTER, 8TH FLOOR, SAN FRANCISCO, CA, 94111, US

(21) Appl. No.: 11/679,051

(22) Filed: Feb. 26, 2007

(51) Int. Cl. H04B 1/56

(52) U.S. Cl. 370/276

(57) ABSTRACT

A node comprising a processor configured to support full-duplex communications with another node over a half-duplex communications protocol.

### BACKGROUND

1. Field

The present disclosure relates generally to communications devices, and more particularly, to the operation of real-time communications over HTTP on communications devices.

2. Background

The introduction of protocols of varying capabilities has led to the inability of some devices, restricted to a particular protocol, to take full advantage of real-time communications. Some of these restricted or limited protocols, e.g., Hypertext Transfer Protocol (HTTP), require that a separate TCP connection be established for each resource (found via a Uniform Resource Identifier or, more commonly a URL). Either these resources can be inline images or other associated data, but both require a client to make multiple requests of the same server in a short amount of time. Each one of these separate connections is comprised of a request/response pair. The amount of volume of request/response pairs can be inordinately high, depending on the amount of resources a client is requesting. The inherent inefficiency in such high volume communications structure increases the load on HTTP servers and causes bandwidth congestion.

Like most network protocols, HTTP uses the client-server model. An HTTP client opens a connection and sends a request message to an HTTP server. The server then returns a response message containing the resource that was requested. After delivering the response, the server closes the connection (making standard HTTP, a stateless protocol, i.e. not maintaining any connection information between transactions).

In general, this request/response transaction is highly ineffective when attempting to create real time communications. This is due, in part, to each HTTP devices inability to provide for full-duplex (contemporaneous two-way transmission) communication. By way of example, an HTTP client node may initiate a request to a server node. A server node receives the request, transmits the resource requested and closes the connection. Because the connection is immediately closed upon fulfillment of the HTTP request, neither the client node nor server node are aware of either ones activity in the interim before establishing a subsequent HTTP connection. This creates a problem when users are attempting to interact in a real-time environment wherein both the client and server nodes must be in constant communication with each other in order to be aware of one another's status. Thus, there is a need for a system that gives devices the ability to communicate in real-time over a protocol that inherently precludes the nodes from communicating in this manner.

### SUMMARY

One aspect of a node is disclosed. A node includes a processor configured to support full-duplex communications with another node over a half-duplex communications protocol.

One aspect of a method of communicating form a node is also disclosed. The method includes supporting full-duplex communications with another node over a half-duplex communications protocol.

Another aspect of a node is disclosed. The node includes a means for supporting full-duplex communications with another node over a half-duplex communications protocol; and means for transmitting a network client identifier to said another node.

An aspect of a computer readable medium is disclosed. A computer readable medium embodying a program of instructions executable by a processor, the instructions including code to support full-duplex communications with another node over a half-duplex communications protocol.

### BRIEF DESCRIPTION OF DRAWINGS

Aspects of the present invention are illustrated by way of example, and not by way of limitation, in the accompanying drawings wherein:

FIG. 1 is a conceptual block diagram illustrating a multiple client node layout for the real time communications system;

FIG. 2 is an example of a hardware configuration for the software-based real time communications system of FIG. 1;

FIG. 3 is a layered presentation of an embodiment of a real time communications system; and

FIG. 4 is a flow chart of an illustrative embodiment of a real time communications system.

### DETAILED DESCRIPTION

The detailed description set forth below in connection with the appended drawings are intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well-known structures and components are shown in block diagram form in order to avoid obscuring the concepts of the invention.

The various concepts described throughout this disclosure may be applied to any group of nodes in a communications system. The nodes may be any combination of desktop computers, laptop computers, client workstations, server-enabled computers, dedicated servers, mainframes, mobile telephones, personal digital assistants (PDAs), games consoles, or other suitable nodes. In the following detailed description, these concepts will be described in the context of a server and client node configured to interact in real-time communications over HTTP. However, as those skilled in the art will appreciate, these concepts are not limited such applications, but may extend to any group of nodes engaging in real-time communications over a half-duplex communications protocol. A “half-duplex communications protocol” means a protocol that does not allow bidirectional transmission of data at the same time. “Real-time,” as used herein, figuratively describes the level of interaction that one would achieve in adopting this system but it is not to be literally construed.

In one exemplary embodiment of a communications system, a client node may wish to engage in real-time communications with a server node, or with another client node via a facilitating server node, over a half-duplex communications protocol. In either case, the client node sends a request to a server node to establish a downstream communication session to support real-time communications. The client node's initial request may be performed by using a standard protocol command invoked for obtaining information—for example, in the case of HTTP, an HTTP GET command is typically used. One of ordinary skill in the art may appreciate that this initial request may also be performed at the server node, thus, bypassing the traditional HTTP limitation of only allowing client's to initiate requests.

In response to the client node's initial request, the server node generates a network client identifier (NCID) that is used to identify the client node that has made the request. The NCID, together with any data responsive to the client node's request, is sent by the server node to the client node to establish the downstream communications session. The data may include, by way of example, preliminary application data that the client node uses to engage in real-time communications with the server node or another client node.

Upon receipt of the NCID, the client node makes a second request to the server node to establish an upstream communications session. The client node's second request may be performed by using another standard protocol command invoked for sending information—for example, in the case of HTTP, an HTTP PUT or POST command is typically used. Once the server node acknowledges the client node's second request, the client node transmits the NCID back to the server node to open the upstream communications session. The server node uses the newly received NCID to match it with the corresponding NCID it had sent to the client node via the downstream communication session. Once the server node positively matches the initially generated NCID with the received NCID, the server node pairs the downstream and upstream communications sessions to provide one logical communications channel that continues transmitting and receiving data until termination is requested by the client node. The logical communications channel may be used to support real-time communications between the client and server node. Alternatively, the logical communications channel may be used to support real-time communications with another client node that established downstream and upstream communication sessions with the server node in a manner similar to that described above.

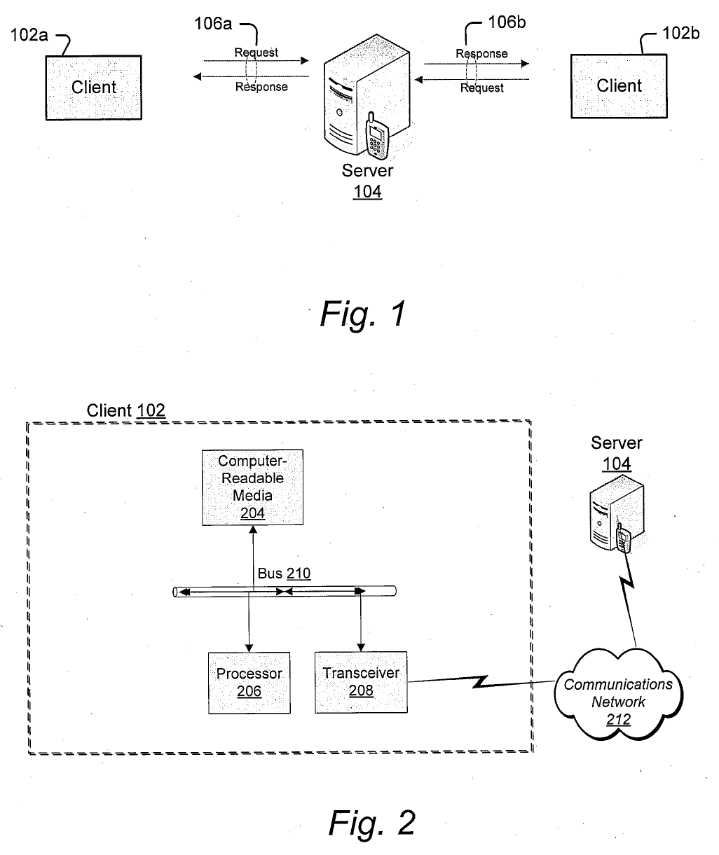

FIG. 1 is a conceptual block diagram illustrating a multiple client node layout for the real-time communications system. In this example, client nodes 102a, 102b engage in real-time communications via a facilitating server node 104 by taking advantage of a single request/response pair 106a, 106b, respectively, that remain open until terminated by the client nodes 102a, 102b. Creating a single request/response pair 106a, 106b, allows the client node 102 and server node 104 to perform asynchronous communication, i.e. both asynchronous send and asynchronous receive. In the manner described above, both client nodes 102a, 102b establish a logical communications channel with the serving node 104. Because the real-time communication applications on both client nodes 102a, 102b are being run over a half-duplex communications protocol, the server node 104 continuously responds to each of the client node's 102a, 102b initial request through periodic activity to keep the downstream communication sessions for both client nodes 102a, 102b open. The periodic activity may be application data, or in the absence of any application data, keep alive data. Likewise, each client node 102a, 102b provides periodic activity to the server node 104 to keep the upstream communication sessions for both client nodes 102a, 102b open. The periodic activity may be application data, or in the absence of any application data, keep alive data.

FIG. 2 is a conceptual block diagram illustrating an example of a hardware configuration for the software-based real time communications system of FIG. 1. The client node 102 may be implemented with a number of components connected by a bus 210. A processor 206 may be implemented in hardware, firmware, middleware, software, or any combination thereof. In one embodiment, the processor 206 includes a general purpose processor, such as a microprocessor, capable of supporting multiple software programs. These software programs may perform various functions, such as creating and maintaining the logical communications channel with a server node 104 over a half-duplex communications protocol. These software programs may also include applications to support real-time communications with the server node 104, or another node (not shown). Those skilled in the art will recognize the interchangeability of hardware, firmware, middleware, and software configurations in these nodes, and how best to implement the described functionality for each particular application.

The client node 102 also includes computer-readable media 204, which provides temporary and/or permanent storage for the software programs used by the processor 206. The computer-readable media 204 may be a stand-alone entity as shown in FIG. 2, or integral to the processor 206, in whole or part. The computer-readable media may include RAM, SRAM, or SDRAM memory, flash memory, ROM memory, EPROM memory, EEPROM memory, registers, hard disk, a removable disk, a CD-ROM, DVD, CD, tape back-up, reel-to-reel, and/or any other form of storage media known in the art. Those skilled in the art will recognize that the term “computer-readable media” includes any type of storage device that is accessible by the processor 206 and also encompasses a carrier wave that encodes a data signal

Although the hardware layout of FIG. 2 depicts a client node 102 as comprising the hardware components 204, 206, 208, and 210, one skilled in the art would appreciate that the representation could just as equally apply to the server node 104. The communications network 212 can be any suitable network including, by way of example, a cellular network or a wireless local area network (LAN) such as Wi-Fi, Wi-Max, or the like. Alternatively, the communications network can be a wide area network (WAN) consisting of routers and public communication lines including leased lines, circuit-switched networks, packet-based networks, and the like. The largest and most well-known example of a WAN is the Internet. The server and client node may have a wired or wireless connection. Examples of wired connections include Ethernet systems, DSL, cable modem, fiber optics, standard telephone lines, and others. Examples of wireless connections include cellular systems, wireless LANs, and others.

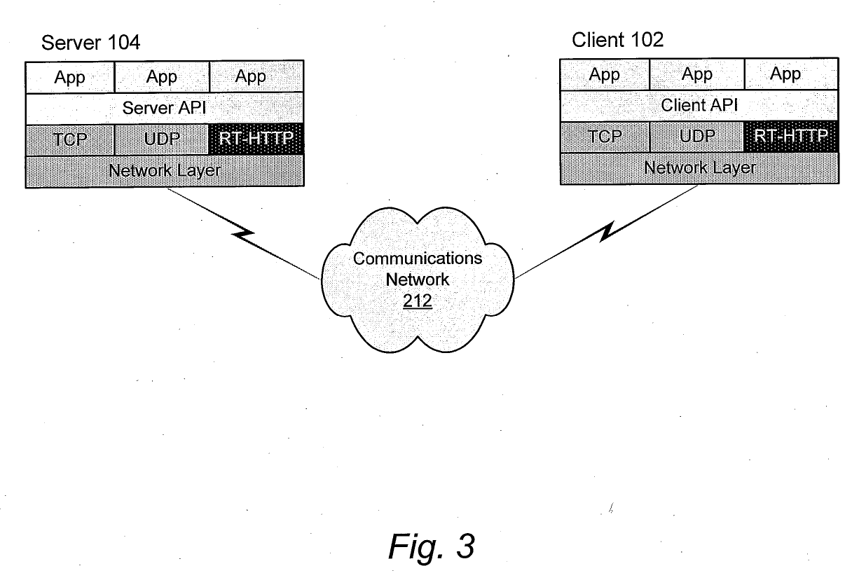

FIG. 3 is a layered representation of an embodiment of a real time communications system. As illustrated, one skilled in the art can appreciate that any application that interfaces with the server or client API can take advantage of the various concepts disclosed herein without having to make any modifications if already configured to communicate over standard HTTP via TCP. These concepts will be referred to in this example as “real-time HTTP” or “RT-HTTP.” The multiple Application objects (“App”) illustrated within client node 102 and server node 104 indicate the independence of RT-HTTP as compared to application interaction due to the server node 104 or client node 102 API. The server node 104 API and client node 102 API are source code interfaces that the nodes provide in order to support requests for services (e.g., real time communications) by individual Apps. Although the RT-HTTP object has been visually depicted in the transport layer as illustrated alongside TCP and UDP, one skilled in the art would recognize that this logical representation is for ease of interpreting how RT-HTTP provides real time communications. True HTTP is an application layer protocol subject to all the limitations as earlier explained, but due to the novel implementation of RT-HTTP, it is more accurately described as a transport layer “protocol.”

Further, the client node 102 and the server node 104 possess a network layer that interfaces with a communications network 212. The network layer simply facilitates communication between the nodes but is not dependent on a particular communication protocol, e.g. TCP, UDP, etc. Thus, no modification of a pre-existing network layer is necessary in order to implement RT-HTTP. Accordingly, in order for the server node 104 and the client node 102 to communicate over the communications network 212, both the server node 104 and the client node 102 simply need to be configured with an RT-HTTP component that operates just above the network layer, but otherwise looks transparent to layers above and below the RT-HTTP component.

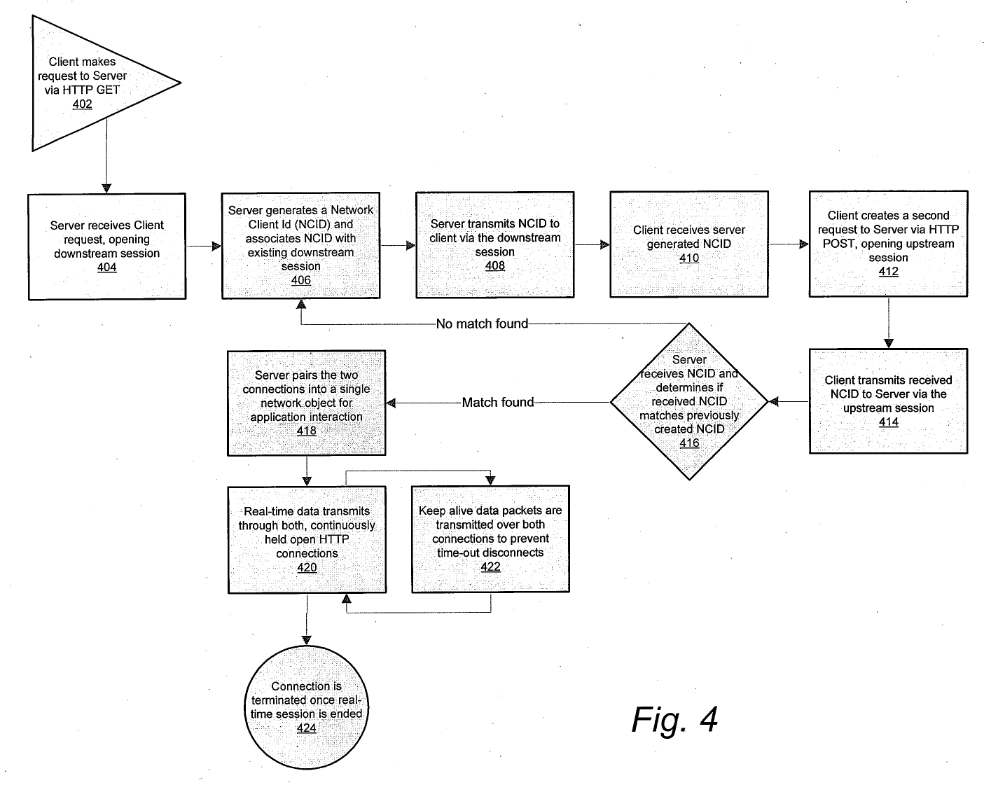

FIG. 4 is a flow chart of an illustrative embodiment of a real time communications system. Referring to FIGS. 1, 2 and 4, in step 402, a client node 102 makes a request to a server node 104 using a standard HTTP method. The request is managed by the processor 206 and is transmitted to the server node 104 via a transceiver 208. In step 404, the server node 104 receives the request and responds with data that instructs the client node 102 to keep the connection open and thereby, opening a downstream communications session. In step 406, the server node 104 generates an NCID and associates the NCID with the newly created downstream communications session. In step 408, the server node 104 transmits the NCID over a communications network 212 to the client node 102 that made the initial request. The client node 102 then subsequently receives the server node 104 assigned NCID in step 410 and further generates a second request to the server node 104 in step 412. The second request, also using standard HTTP method, differs from the initial request in that the second request transmits data from the client node 102 to the server node 104. The opening of the second request creates an upstream communications session.

The NCID residing on the client node 102 is transmitted to the server node 104 via the upstream communications session in step 414. In step 416, the server node 104 determines whether the received NCID from the client 104 matches an NCID it has assigned to a prior created downstream communications session. If no match is found, the server node 104 may either fail the attempted real-time HTTP connection or attempt to general a second NCID by returning to step 406. Otherwise, if a match is found, in step 418, the server node 104 pairs the two communications sessions established with the client node 102 and creates a single network object to interface with higher level layers like applications or anything needing to interact over a communications network 212. In step 420, real-time data is transmitted over the continuously held open pair of HTTP connections. In instances where no true data is transmitted across the connections and to prevent time out disconnects due to inactivity, the system is configured to send periodic activity in the form of keep alive data packets to keep the upstream and downstream sessions open and active. Once the client node 102 wishes to terminate the real-time connection, the client node 102 sends a termination request to the server node 104 and the upstream and downstream communications sessions are terminated in step 424.

The functionality of two nodes is described with reference to FIG. 4 to illustrate the real-time communications concept. Those skilled in the art will readily understand that one or more steps described in FIG. 4 may be omitted and/or altered depending upon the specific application and the overall design constraints imposed on the overall system.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language of the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A node, comprising:
a processor configured to support full-duplex communications with another node over a half-duplex communications protocol.

2. The node of claim 1 wherein the processor is further configured to open downstream and upstream communications sessions with said another node.

3. The node of claim 2 wherein the upstream and downstream communications sessions require periodic activity to keep the upstream and downstream communications sessions open.

4. The node of claim 3 wherein the processor is further configured to provide sufficient activity to said another node to maintain the upstream and downstream communication sessions open.

5. The node of claim 2 wherein the node comprises a server node, and wherein the processor is further configured to assign a network client identifier to said another node to pair the downstream and upstream communications sessions together.

6. The node of claim 2 wherein the node comprises a server node, the server node further comprising a transceiver configured to transmit a network client identifier to said another node to pair the downstream and upstream communications sessions together.

7. The node of claim 2 wherein the node comprises a client node, the client node further comprising a transceiver configured to receive a network client identifier via the downstream communications session with said another node and transmit the network client identifier via the upstream communications sessions to said another node.

8. The node of claim 1 wherein the half-duplex communications protocol is HTTP.

9. The node of claim 2 wherein the processor is further configured to establish the upstream communications session and downstream communications session over a wireless communications network.

10. The node of claim 1 wherein the processor is configured to initiate communication with said another node.

11. The node of claim 1 wherein the processor is further configured to support asynchronous communication with said another node.

12. A method of communicating from a node, comprising:
supporting full-duplex communications with another node over a half-duplex communications protocol.

13. The method of claim 12 wherein the node comprises a server node, and said another node comprises a client node, wherein the supporting of full-duplex communications further comprises opening, on the client node, a downstream communications session.

14. The method of claim 13 wherein the supporting of full-duplex communications further comprises assigning a network client identifier to the client node.

15. The method of claim 14 wherein the supporting of full-duplex communications further comprises transmitting the network client identifier from the server node to the client node on the downstream communication session, opening, on the client node, an upstream communications session with the server node, and receiving the network client identifier from the client node via the upstream communications session.

16. The method of claim 15 wherein the supporting of full-duplex communications further comprises pairing the downstream communications session and the upstream communications session together.

17. The method of claim 16 wherein the supporting of full-duplex communications further comprises maintaining the downstream communications session and the upstream communications session open until a termination request is received.

18. The method of claim 17 wherein the maintaining of the open downstream communications session and the upstream communications session further comprises preventing a time-out disconnect.

19. The method of claim 18 wherein the preventing of a time-out disconnect of the downstream communications session and the upstream communications session further comprises providing sufficient activity.

20. The method of claim 14 wherein the opening of the downstream communication session is in response to a request from the client node.

21. The method of claim 14 wherein the opening of the downstream communication session is in response to a request from the server node.

22. The method of claim 15 wherein the supporting of full-duplex communications further comprises establishing the upstream communications session and downstream communications session over a wireless communications network.

23. The method of claim 12 wherein the supporting of full-duplex communications further comprises supporting asynchronous communication with said another node.

24. A node, comprising:
means for supporting full-duplex communications with another node over a half-duplex communications protocol; and
means for transmitting a network client identifier to said another node.

25. The node of claim 24 wherein the means for supporting full-duplex communications with another node further comprises means for opening a downstream and an upstream communications sessions with said another node.

26. The node of claim 25 wherein the means for supporting full-duplex communications with another node further comprises means for transmitting periodic activity to keep the upstream and downstream sessions open.

27. The node of claim 26 wherein the means for supporting full-duplex communications with another node further comprises means for assigning a network client identifier to said another node to pair the upstream and downstream sessions.

28. A computer readable medium embodying a program of instructions executable by a processor in a node, the instructions comprising:
code to support full-duplex communications with another node over a half-duplex communications protocol.

29. The computer readable medium of claim 28 further comprising code to assign a network client identifier for pairing an upstream communications session and a downstream communications session.

30. The computer readable medium of claim 28 wherein the code to support full-duplex communications with another node opens a downstream communications session with another device, transmits and receives a network client identifier, opens an upstream communications session, pairs the independently created downstream and upstream communications sessions, and maintains open the downstream and upstream communications sessions until a connection termination request is received.

31. The computer readable medium of claim 30 wherein the code to support full-duplex communications with another node further comprises code to prevent a time-out of the upstream and downstream communications sessions by transmitting periodic activity.
